(19) United States
(12) Patent Application Publication
(10) Pub. No.: US 2026/0046061 A1
(43) Pub. Date: Feb. 12, 2026

(54) RATE-MATCHING PATTERNS

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Qian ZHANG, Basking Ridge, NJ (US)

(21) Appl. No.: 18/798,691

(22) Filed: Aug. 8, 2024

(51) Int. Cl. H04L 1/00; H04L 5/00; H04L 5/14

(52) U.S. Cl. CPC H04L 1/0013; H04L 5/0094; H04L 5/14

(57) ABSTRACT

Aspects of the disclosure are directed to methods and techniques for wireless communications, and in particular to applying a rate-matching pattern to an uplink communication. In certain aspects, a wireless node may obtain an indication of a rate-match pattern. In certain aspects, the wireless node may output, via subband full duplex (SBFD) resources, signaling for transmission according to the rate-match pattern.

### BACKGROUND

### Technical Field

The present disclosure generally relates to communication systems, and more particularly, to rate matching patterns for muting one or more resources in a subband full duplex (SBFD) communication.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors, alone or in combination, are configured to obtain an indication of a rate-match pattern. In some examples, the one or more processors, alone or in combination, are configured to output, via subband full duplex (SBFD) resources, signaling for transmission according to the rate-match pattern.

Aspects are directed to an apparatus for wireless communication. In some examples, the apparatus includes one or more memories, individually or in combination, having instructions. In some examples, the apparatus includes one or more processors, individually or in combination, configured to execute the instructions. In some examples, the one or more processors, alone or in combination, are configured to output, for transmission, an indication of a rate-match pattern. In some examples, the one or more processors, alone or in combination, are configured to obtain, via subband full duplex (SBFD) resources, signaling according to the rate-match pattern.

Aspects are directed to a method for wireless communication at a wireless node. In some examples, the method includes obtaining an indication of a rate-match pattern. In some examples, the method includes outputting, via subband full duplex (SBFD) resources, signaling for transmission according to the rate-match pattern.

Aspects are directed to a method for wireless communication at a wireless node. In some examples, the method includes outputting, for transmission, an indication of a rate-match pattern. In some examples, the method includes obtaining, via subband full duplex (SBFD) resources, signaling according to the rate-match pattern.

Aspects are directed to an apparatus for wireless communication. In some examples, the apparatus includes means for obtaining an indication of a rate-match pattern. In some examples, the apparatus includes means for outputting, via subband full duplex (SBFD) resources, signaling for transmission according to the rate-match pattern.

Aspects are directed to an apparatus for wireless communication. In some examples, the apparatus includes means for outputting, for transmission, an indication of a rate-match pattern. In some examples, the apparatus includes means for obtaining, via subband full duplex (SBFD) resources, signaling according to the rate-match pattern.

Aspects are directed to a non-transitory, computer-readable medium comprising computer executable code, the code when executed by one or more processors causes the one or more processors to, individually or in combination, perform a method of wireless communication. In some examples, the method includes obtaining an indication of a rate-match pattern. In some examples, the method includes outputting, via subband full duplex (SBFD) resources, signaling for transmission according to the rate-match pattern.

Aspects are directed to a non-transitory, computer-readable medium comprising computer executable code, the code when executed by one or more processors causes the one or more processors to, individually or in combination, perform a method of wireless communication. In some examples, the method includes outputting, for transmission, an indication of a rate-match pattern. In some examples, the method includes obtaining, via subband full duplex (SBFD) resources, signaling according to the rate-match pattern.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram conceptually illustrating time-frequency resources for in-band full duplex (IBFD) wireless communication schemes.

FIG. 6 is a block diagram conceptually illustrating time-frequency resources for a subband full duplex (SBFD) wireless communication scheme.

FIGS. 7A-7C illustrate various modes of duplex communication.

FIG. 8 is a call-flow diagram illustrating example communications between a UE and a network entity.

FIG. 9 is a flowchart of a method of wireless communication.

FIG. 10 is a diagram illustrating an example of a hardware implementation for an example apparatus.

FIG. 11 is a flowchart of a method of wireless communication.

FIG. 12 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

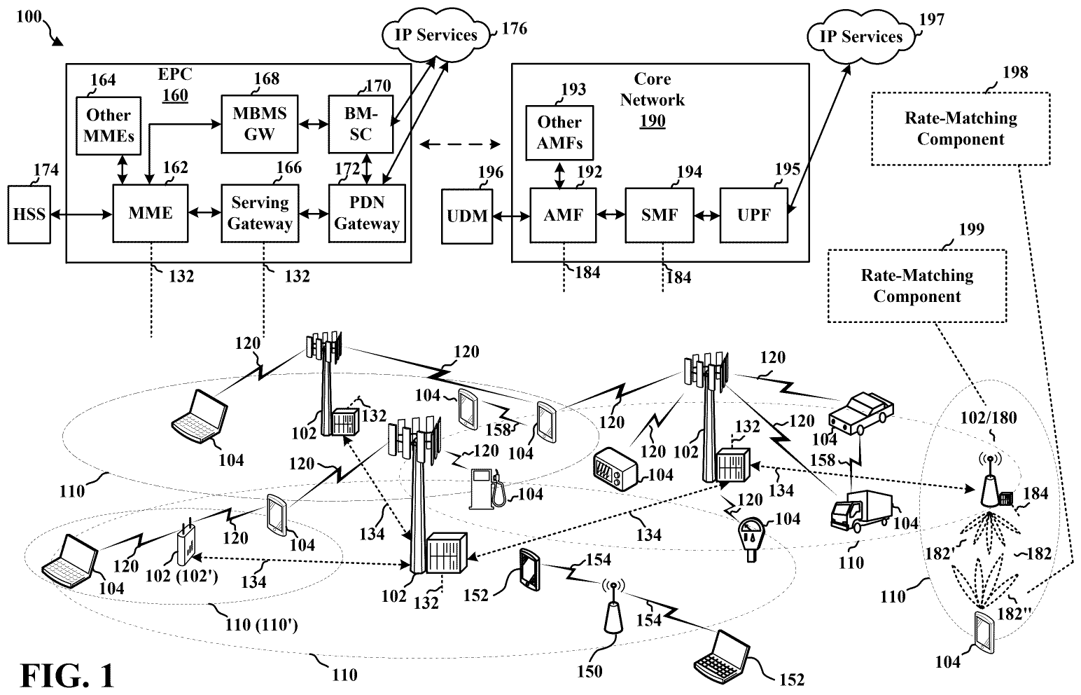

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more, or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave”band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include a rate-matching component 198. As described in more detail elsewhere herein, the rate-matching component 198 may be configured to obtain an indication of a rate-match pattern; and output, via subband full duplex (SBFD) resources, signaling for transmission according to the rate-match pattern. Additionally, or alternatively, the rate-matching component 198 may perform one or more other operations described herein.

The base station 102/180 may include another rate-matching component 199. As described in more detail elsewhere herein, the rate-matching component 199 may be configured to output, for transmission, an indication of a rate-match pattern; and obtain, via subband full duplex (SBFD) resources, signaling according to the rate-match pattern. Additionally, or alternatively, the rate-matching component 199 may perform one or more other operations described herein.

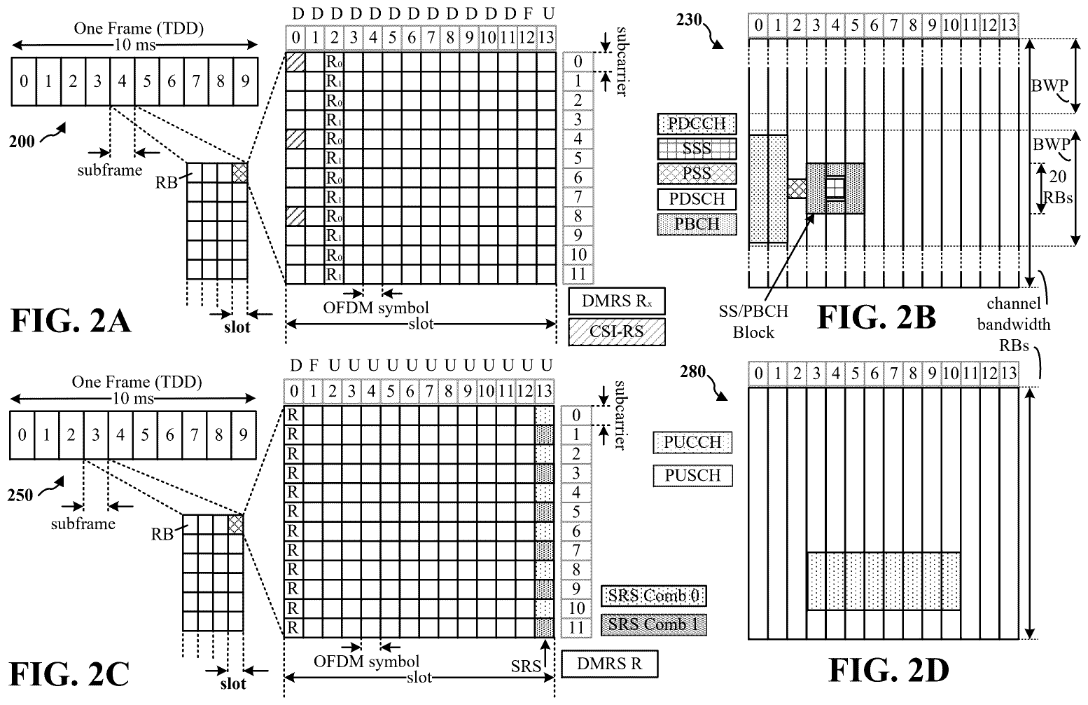

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ}slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

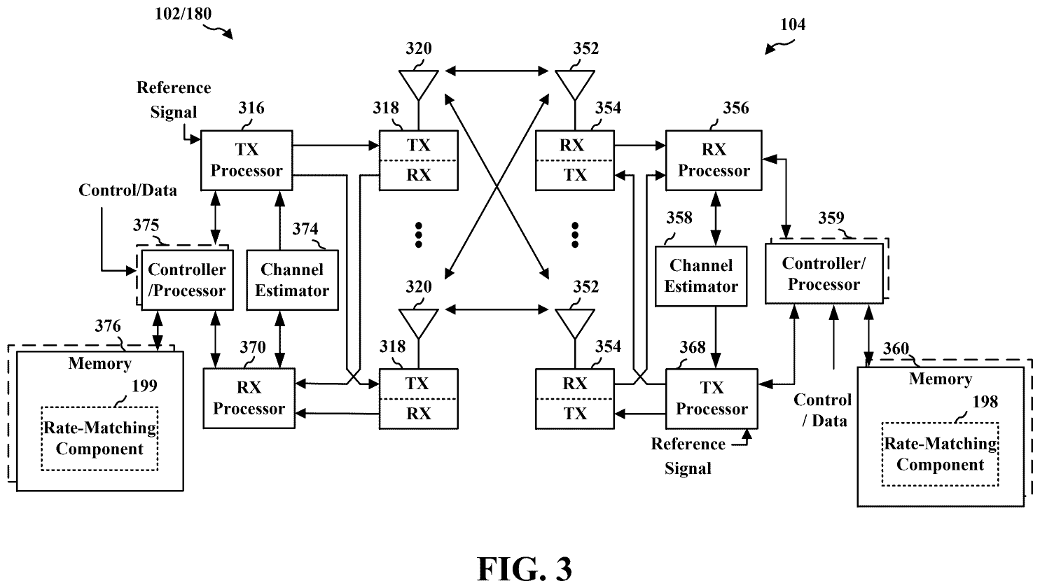

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer) In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

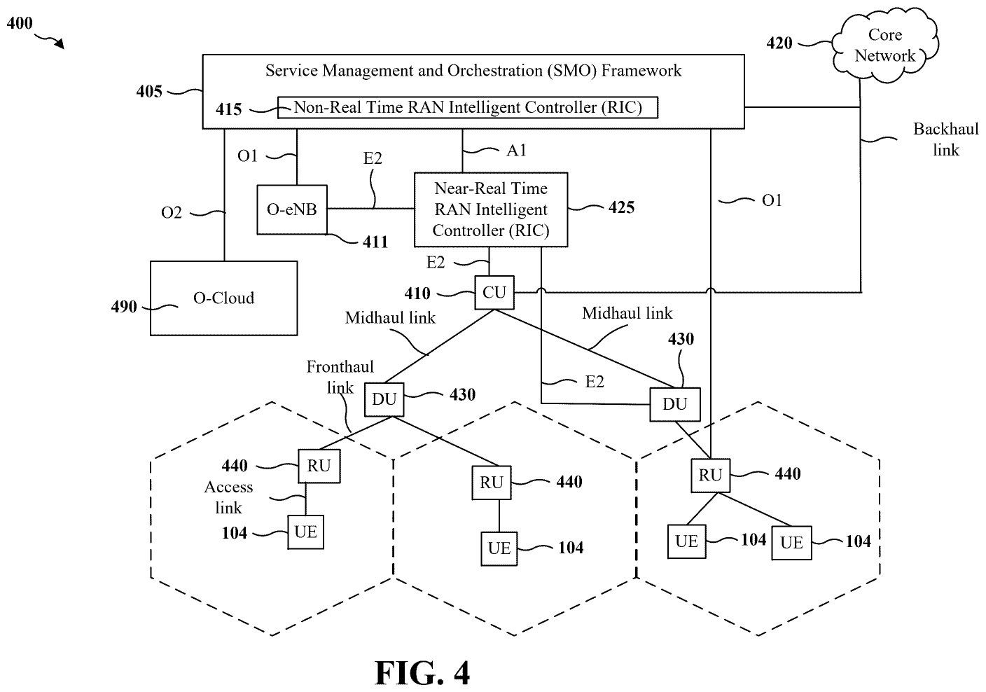

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit—user plane (CU-UP)), control plane functionality (i.e., central unit—control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

### Examples of Full Duplex Communications

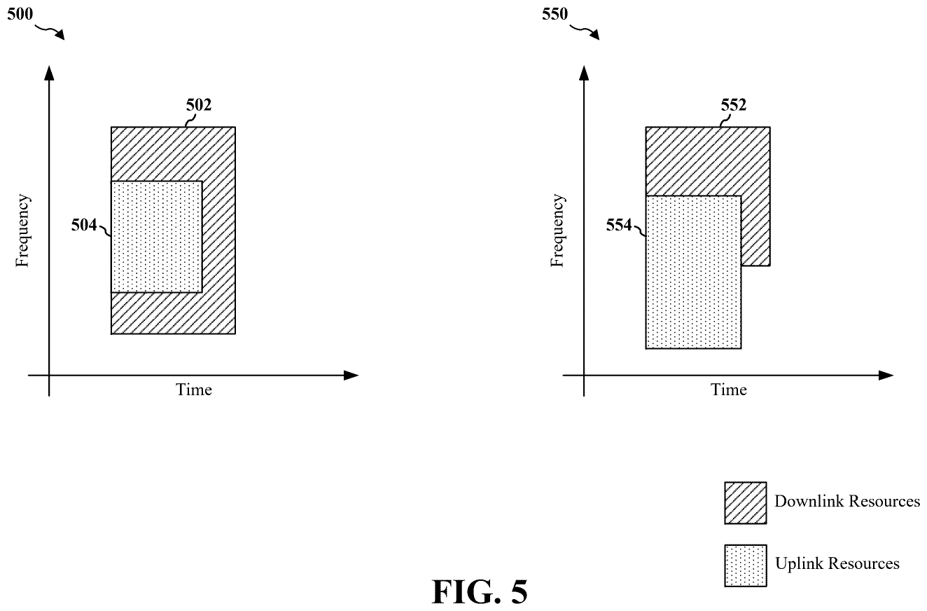

FIG. 5 is a block diagram conceptually illustrating time-frequency resources for in-band full duplex (IBFD) wireless communication schemes. A first IBFD scheme 500 shows a full overlap of downlink resources 502 and uplink resources 504 in time and frequency. That is, a downlink transmission and an uplink transmission share the same time and frequency resources. The downlink resources 502 and uplink resources 504 may be resources used for a UE-to-UE communication link or a UE-to-gNB communication link. A second IBFD scheme 550 shows a partial overlap of downlink resources 552 with uplink resources 554. Here, the downlink resources 552 and the uplink resources 554 are offset from each other by frequency and/or time.

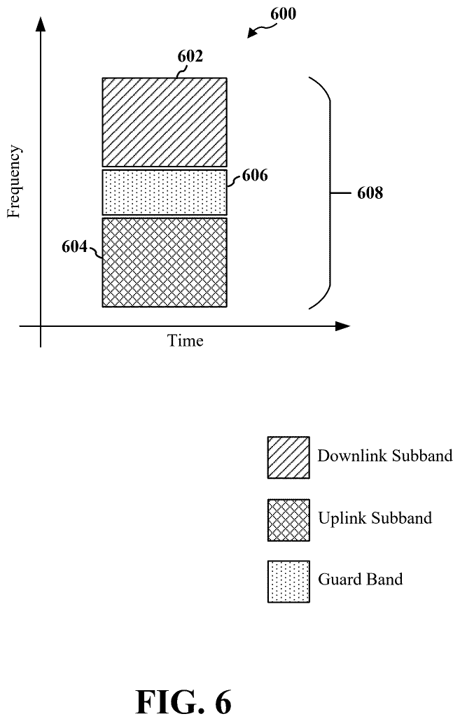

FIG. 6 is a block diagram conceptually illustrating time-frequency resources for an SBFD scheme 600 that includes a downlink subband 602, a guard band subband 606, and an uplink subband 604. In some examples, bandwidth 608 of the aggregated subbands may correspond to a system bandwidth or a component carrier bandwidth. Thus, from the perspective of a UE, a first antenna array may be dedicated to downlink reception via the downlink subband 602, whereas a second antenna array may be dedicated to uplink transmission via the uplink subband 604. Note that neither the uplink subband 604 nor the downlink subband 602 occupy the entire frequency resource range (e.g., the frequency band) for SBFD communication.

Thus, in one example, an SBFD slot may relate to a slot in which the corresponding frequency band is separated into subbands, with each subband dedicated for one of uplink or downlink transmissions. The uplink and downlink transmissions may occur in adjacent bands (e.g., subbands) as opposed to an IBFD communication with overlapping bands. In a given SBFD slot, a half-duplex UE may either transmit in the uplink band or receive in the downlink band, while a full duplex UE may transmit in the uplink band and/or receive in the downlink band of the same slot.

### Examples of Cross Link Interference (CLI)

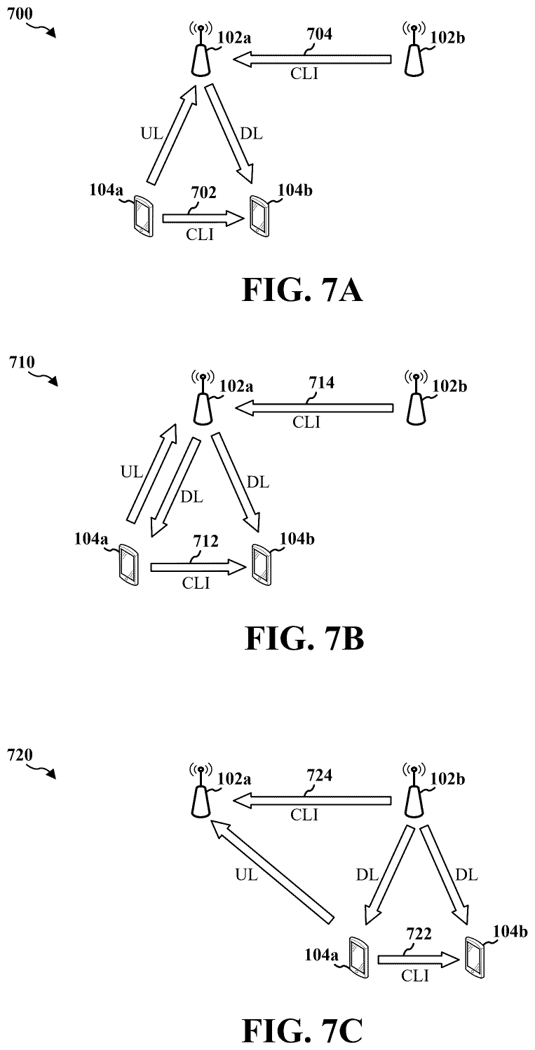

FIGS. 7A, 7B, and 7C illustrate various modes of duplex communication. As discussed, full-duplex communication may support transmission and reception of information (e.g., uplink and downlink communication) in the same frequency range (e.g., on one or more frequency bands) in a manner that overlaps in time. The frequency range may include a common set of frequency bands (e.g., the same frequency bands), fully overlapping frequency bands, or partially overlapping frequency bands. For example, in-band full-duplex (IBFD) operation may include the transmission and reception of signals at overlapping times and overlapping in frequency. In subband full duplex (SBFD), transmission and reception resources may overlap in time using different frequencies, e.g., separated by a guard band. The transmission and reception frequency resources may be close enough that interference cancellation methods are used to cancel interference from the transmitted signal. In this manner, the full-duplex communication may have an improved spectral efficiency relative to a half-duplex (HD) communication, which may support transmission or reception of information in one direction at a time without overlapping uplink and downlink communication. A UE or a network entity operating in the full-duplex mode may simultaneously transmit and receive full-duplex communication. However, in full duplex, the UE or network entity may experience cross-link interference (CLI) from other network devices, such as transmissions from another UE or another network entity. Such interference may impact the quality of the communication, or even lead to a loss of information.

FIG. 7A illustrates a first example of full-duplex communication 700 in which a first network entity 102a (e.g., network entity 102 of FIGS. 1 and 3) may be in full-duplex communication with a first UE 104a (e.g., UE 104 of FIGS. 1 and 3) and a second UE 104b. The first network entity 102a may be a full-duplex network entity. Although the first UE 104a and the second UE 104b are illustrated as communicating in a half-duplex mode, either UE may be configured for half-duplex or full-duplex communication. The first UE 104a may be in proximity to the second UE 104b and may transmit a first uplink signal to the first network entity 102a. The first network entity 102a may transmit a downlink signal to the second UE 104b concurrently with receiving the uplink signal from the first UE 104a. The second UE 104b may experience a first instance of CLI 702 caused by the uplink signals transmitted from the first UE 104a (e.g., the second UE 104b receives interference from the uplink signals while receiving the downlink signaling from the first network entity 102a). The first network entity 102a may experience a second instance of CLI 704 due to signals from the second network entity 102b (e.g., the first network entity 102a receives interference from signals transmitted by the second network entity 102b while receiving the uplink signaling from the first UE 104a).

FIG. 7B shows a second example of full-duplex communication 710 in which a first network entity 102a may be in full-duplex communication with a first UE 104a. In this example, the first network entity 102a may be a full-duplex network entity, and the first UE 104a may also be a full-duplex UE. That is, the first network entity 102a and the first UE 104a may concurrently receive and transmit communication that overlaps in time in the same frequency band. A second UE 104b may experience a first instance of CLI 712 based on one or more uplink signals transmitted from the first UE 104a. Moreover, the first network entity 102a may experience a second instance of CLI 714 caused by a collision of signals transmitted from a second network entity 102b and uplink signals transmitted by the first UE 104a.

FIG. 7C shows a third example of full-duplex communication 720 in which a first UE 104a is a full-duplex UE in communication with a first network entity 102a and a second network entity 102b. The first network entity 102a and the second network entity 102b may serve as multiple transmission and reception points (multi-TRPs) for UL and DL communication with the first UE 104a. The second network entity 102b may also be in communication with a second UE 104b. In FIG. 7C, the first UE 104a may concurrently transmit an uplink signal to the first network entity 102a while receiving a downlink signal from the second network entity 102b. The second UE 104b may experience a first instance of CLI 722 a result of the uplink signaling from the first UE 104a being transmitted at the same time the second UE 104b receives a downlink signal. The first network entity 102a may also experience a second instance of CLI 724 caused by signals transmitted by the second network entity 102b and uplink signaling transmitted by the first UE 104a.

### Examples of Rate Matching Patterns for Muting Resources in Subband Full Duplex (SBFD) Communications

As discussed above, CLI may cause data loss and latencies associated with full duplex communications. Accordingly, full duplex wireless communications systems could be improved with interference management mechanisms for measuring and reporting CLI. Referring to aspects of the examples of FIGS. 7A-7C, a network entity (e.g., first network entity 102a of FIGS. 7A-7C) may determine to perform a channel estimation process to measure CLI between it and another network entity (e.g., the second network entity 102b of FIGS. 7A-7C). However, if both of a first UE (e.g., first UE 104a of FIGS. 7A-7C) and the second network entity 102a are transmitting signaling to the first network entity 102a at the same time, uplink signaling from the first UE 104a may reduce the accuracy of an estimation of the channel between the first network entity 102a and the second network entity 102b.

Thus, aspects of the disclosure are directed to muting (e.g., via rate matching) uplink resources in order to reduce or eliminate interfering signaling caused by a simultaneous uplink transmission from a UE, thereby enhancing inter-network entity CLI measurement. In one example, a network entity may configure (e.g., via RRC configuration messaging) a UE with an indication of one or more rate match patterns. The network entity may schedule the UE for an uplink transmission and an indication of a particular rate match pattern that the UE may apply to the uplink transmission. Thus, the rate match pattern may be applied to uplink transmissions statically or semi-statically. By applying the rate match pattern to an uplink transmission, the UE may refrain from transmitting signaling via resources corresponding to the indicated rate match pattern. In other words, the rate match pattern provides the UE with an indication of which resources are muted (e.g., no uplink signaling is transmitted via the resources indicated by the rate match pattern).

In some examples, the one or more rate match patterns may be defined by a comb-2 pattern (e.g., where every other RE of an uplink transmission is muted) for both discrete Fourier transform-spread-orthogonal frequency division multiplexing (DFT-S-OFDM) and cyclic prefix-orthogonal frequency division multiplexing (CP-OFDM). In some examples, such a rate match pattern may be configured so that the UE applied the pattern to each allocated uplink resource block (RB) and/or up to two symbols in the time-domain. Accordingly, rate matching patterns may be configured to cause a UE to mute (e.g., not transmit over) REs and/or RBs within allocated uplink resources (e.g., PUSCH and/or PUCCH).

In certain aspects, a network entity may configure a UE with one or more rate-matching patterns via an RRC configuration message. In some examples, the rate-matching patterns may be implemented as zero-power uplink resource set configurations. The RRC configuration message may also include a bandwidth part (BWP) IE configured to indicate a particular BWP and an indication of one or more one or more zero-power uplink resource set(s) associated with the BWP. For example, the BWP IE may reference a particular zero-power uplink resource that the UE may use for muting uplink resources associated with an uplink transmission. In some examples, a PUSCH configuration IE within the BWP configuration IE may include the indication of one or more zero-power uplink resource set configurations. Here, the one or more resource set configurations may indicate RE/RB level resources that are unavailable (e.g., reserved) for uplink transmission. Thus, the UE may refrain from transmitting signaling via the unavailable resources when it transmits an uplink communication. In some examples, a subcarrier spacing (SCS) associated with each of the one or more zero-power uplink resource set configurations may be the same SCS associated with the corresponding BWP within which the set(s) are configured.

It should be noted that a BWP IE may provide an indication of rate-matching patterns that may be implemented on a UE-specific basis. However, in certain aspects, the RRC configuration message may indicate one or more rate-matching patterns that may be implemented on a cell-specific basis. For example, the RRC configuration message may include an indication (e.g., via ServingCellConfig IE) of rate-matching pattern(s) UEs within a particular cell may use for uplink communications. The indication of the rate matching pattern(s) may also provide an indication of an SCS associated with each rate matching pattern. However, because the RRC configuration message may also configure a particular UE with different BWPs associated with different SCSs, which rate-matching pattern the UE uses with a particular uplink transmission may be based on SCS.

In one example, the UE may perform uplink transmissions via an active BWP having an SCS. Here, the UE may select a rate matching pattern that is configured with the same SCS as the active BWP to be used for uplink transmissions via the active BWP. In another example, the indication of the rate matching pattern(s) may omit an indication of an SCS associated with each rate matching pattern. In this example, indicated rate matching pattern(s) may be used with any BWP and SCS.

In certain aspects, the network entity may be configured to include an indication of an SCS only if the rate-matching pattern(s) are configured via a cell-specific RRC IE. For example, if the rate-matching pattern(s) are configured via the cell-specific RRC IE, then the RRC IE may include an indication of an SCS associated with each rate matching pattern. However, if the rate-matching pattern(s) are configured via a UE-specific RRC IE (e.g., via BWP-config) then the SCS may not be included in the UE-specific RRC IE. In this example, the UE may assume that the SCS of the rate-matching pattern(s) are the same as the SCS of the active BWP.

In certain aspects, the network entity may provide the UE with an indication of where (e.g., in terms of one or more of a time-domain and frequency-domain) the UE may apply a rate-matching pattern in an uplink transmission. In one example, if the network entity configures (e.g., via PUSCH-config IE) the UE to apply a particular rate-matching pattern, then the UE may apply that particular pattern to uplink transmissions that are made according to the PUSCH-config IE. That is, the UE may apply a rate-matching pattern configured by PUSCH-config IE associated with a particular BWP to an uplink transmission output via that BWP. Thus, in some examples, the UE may apply the same rate-matching pattern to each slot of an uplink transmission that is transmitted via the associated BWP.

In another example, the network entity may configure the UE with a rate-matching pattern, along with an associated periodicity or offset (e.g., slot offset) for that pattern. Here, the periodicity may indicate a number of slots or a duration of time. For example, if the RRC configuration message indicates that the periodicity associated with a given rate-matching pattern is 2-slots, then the UE may apply the rate-matching pattern to one of every two slots. In another example, if the RRC configuration message indicates that the periodicity is 5 ms (e.g., corresponding to a number of slots within 5 ms, depending on SCS), then the UE may apply the rate-matching pattern to an uplink transmission every 5 ms. Thus, in this example, the UE may apply the rate-matching pattern to an uplink transmission if that transmission falls within a 5 ms window of time. Although the foregoing examples describe scenarios where periodicity is defined by 2-slots or 5 ms, it should be noted that any suitable range of slots and second may be used. For example, periodicity in terms of time may use any value in the following range of values: {1, 2, 4, 5, 8, 10, 20, 40}. The periodicity and/or offset may be a configurable parameter, and may be dynamically or semi-statically changed via DCI, MAC-CE, or RRC message.

In some examples, the network entity may configure the UE with a rate-matching pattern defined in terms of symbols. In one example, the rate-matching pattern may be configured as up to 2-symbols per PUSCH transmission. Here, the UE may be configured apply the rate-matching pattern to 2-symbols for every PUSCH transmission. In another example, the UE may be configured to apply the rate-matching pattern to 1- or 2-symbols every PUSCH transmission. Here, the network entity may configure the UE to alternate between 1- and 2-symbol application of the rate-matching pattern or may provide an indication of a number of symbols when the uplink transmission is scheduled.

In some examples, a maximum bandwidth associated with a rate-match pattern may be defined based on: (i) a bandwidth of an uplink subband (e.g., uplink subband 604 of FIG. 6) of an SBFD communication scheme, (ii) a bandwidth of the active BWP used to transmit an uplink communication with the rate-match pattern applied, or (iii) a bandwidth of a component carrier used to transmit the uplink communication with the rate-match pattern applied. In some examples, the bandwidth may be defined in terms of RB(s).

In some examples, an RE pattern associated with the rate-match pattern (e.g., which REs of a PUSCH transmission are muted by the rate-match pattern) may be defined by a comb-2 pattern. Thus, the rate-match pattern may start at either the first or second RE of a PUSCH transmission. In one example, an RRC configuration message may provide an indication of an RE-offset configured to provide the UE with an indication of whether the rate-match pattern begins at the first RE or the second RE. Here, the RRC configuration message may provide a single integer (0 or 1) so that the UE may determine where the rate-match pattern starts. Accordingly, the RE-offset may be a configurable parameter, and may be dynamically or semi-statically changed via DCI, MAC-CE, or RRC message. In another example, the RE-offset may be a fixed parameter (e.g., cannot be dynamically or semi-statically changed).

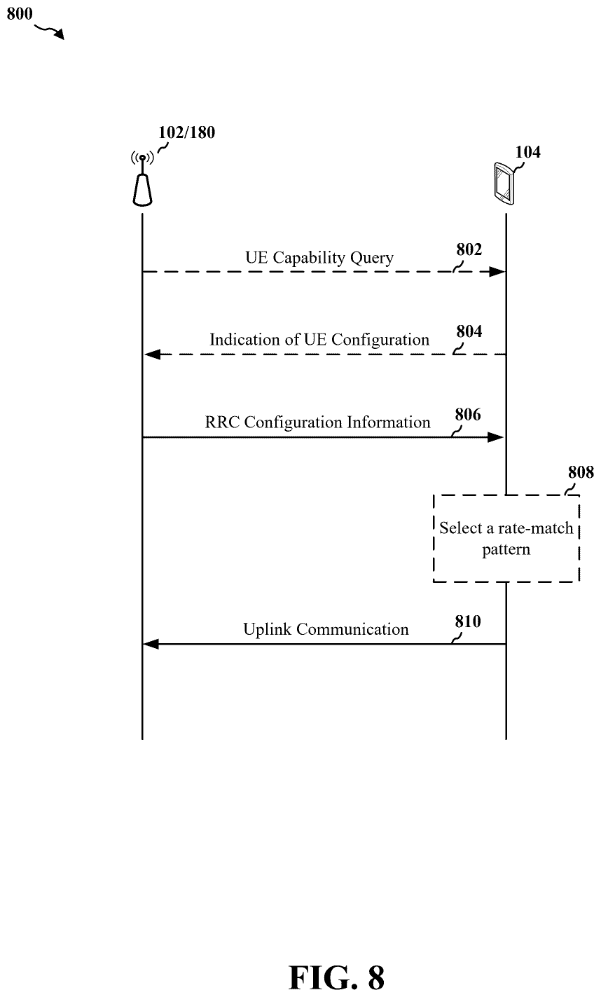

FIG. 8 is a call-flow diagram illustrating example communications 800 between a network entity (e.g., network entity 102 of FIGS. 1 and 3, and first network entity 102a of FIGS. 7A-7C) and a UE (e.g., UE 104 of FIGS. 1 and 3, and first UE 104a of FIGS. 7A-7C).

At a first communication 802, the network entity 102 may optionally transmit a query requesting an indication of capabilities of the UE 104. Specifically, the capability query may be configured to cause the UE 104 to transmit an indication of whether it can support an uplink resource muting capability via rate matching, as described above. At a second communication 804, the UE 104 may optionally transmit a response to the query, indicating whether the UE 104 is capable of uplink resource muting.

At a third communication, the network entity may transmit an indication of one or more rate-match pattern(s) to the UE 104. Here, the UE 104 may receive the indication of the rate-match pattern(s) via an RRC configuration message. The indication of the rate match pattern(s) may be transmitted to the UE 104 via a UE-specific RRC IE, or a cell-specific RRC IE. In some examples, the network entity 102 may also transmit an indication of a particular one of the rate-matching patterns that the UE 104 may use for an uplink transmission. For example, after transmitting the RRC configuration message, the network entity may transmit an uplink grant (e.g., via DCI) to the UE 104, where the uplink grant includes an indication of which rate-matching pattern to use. In some examples, the uplink grant may also include an indication of a periodicity, an SCS, and/or RE-offset that the UE 104 may apply to the rate-matching pattern for the scheduled uplink transmission.

At a first process 808, the UE 104 may optionally select a rate-match pattern. For example, the UE 104 may select a rate-match pattern based on an SCSs associated with each of the one or more rate-match patterns. Thus, if the UE 104 is configured to use a particular BWP for an uplink transmission, and the BWP uses a first SCS, then the UE 104 may select a rate-match pattern that is configured with the same first SCS.

At a fourth communication 810, the UE 104 may transmit an uplink communication, to which a rate-match pattern is applied. In other words, the UE 104 may refrain from transmitting signaling via REs and/or RBs that are muted by the rate-matching pattern. This provides the network entity 102 with an opportunity to receive signaling from another wireless node via the REs and/or RBs muted by the UE 104, so that CLI measured by the network entity 102 based on the received singling has an enhanced accuracy (e.g., no signaling is transmitted by the UE 104 via the muted resources, and thus, the UE 104 does not interfere the signaling received by the from the other wireless node).

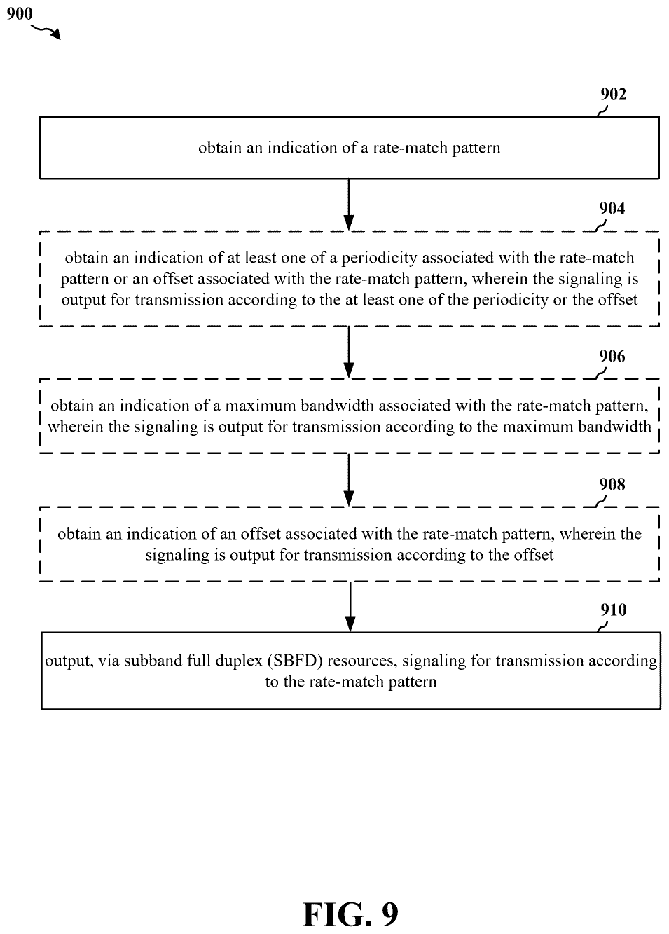

FIG. 9 is a flowchart illustrating a method 900 of wireless communication. The method may be performed by a UE (e.g., the UE 104; the apparatus 1002). Specifically, the method may be performed by one or more memories, processors, and RF front ends (e.g., the memory 360, controller/processor 359, transmitter 354TX, receiver 354RX, antenna 352, etc. of FIG. 3).

At 902, the UE may obtain an indication of a rate-match pattern. For example, 902 may be performed by an obtaining component 1040. Here, the UE may obtain information indicating one or more rate-match patterns, as illustrated in the third communication 806 of FIG. 8.

In certain aspects, the indication of the rate-match pattern is obtained via a bandwidth part (BWP) configuration information element (IE) of a radio resource control (RRC) configuration message.

In certain aspects, the BWP configuration IE is a component of a physical uplink shared channel (PUSCH) configuration IE of the RRC configuration message.

In certain aspects, the signaling is output for transmission according to a subcarrier spacing (SCS) associated with the BWP configuration IE.

In certain aspects, the indication of the rate-match pattern is obtained via a cell-specific configuration information element (IE) of a radio resource control (RRC) configuration message.

In certain aspects, the cell-specific configuration IE comprises an indication of a subcarrier spacing (SCS), and wherein the signaling is output for transmission via a bandwidth part (BWP) configured with a same subcarrier spacing (SCS) indicated by the cell-specific configuration IE.

In certain aspects, the signaling is output for transmission via a bandwidth part (BWP) by using a subcarrier spacing (SCS) associated with the BWP.

In certain aspects, the signaling is output for transmission via a physical uplink shared channel (PUSCH), and/or the rate-match pattern is configured as a 1-symbol pattern or a 2-symbol pattern per PUSCH transmission.

In certain aspects, the indication of the rate-match pattern further comprises an indication of a fixed offset.

At 904, the UE may optionally obtain an indication of at least one of a periodicity associated with the rate-match pattern or an offset associated with the rate-match pattern, wherein the signaling is output for transmission according to the at least one of the periodicity or the offset. For example, 904 may be performed by the obtaining component 1040. Here, the network entity may transmit the indication via an RRC message, a DCI, or a MAC-CE. In some examples, the indication of the periodicity or the offset associated with the rate-match pattern may be included in the same messaging used for transmission of the indication of the rate-match pattern (e.g., periodicity/offset indicated in the third communication 806 of FIG. 8).

At 906, the UE may optionally obtain an indication of a maximum bandwidth associated with the rate-match pattern, wherein the signaling is output for transmission according to the maximum bandwidth. For example, 906 may be performed by the obtaining component 1040. Here, the UE may determine frequency resources to which the rate-matching pattern is applied. In some examples, the indication of the bandwidth may be included in the same messaging used for transmission of the indication of the rate-match pattern (e.g., bandwidth indicated in the third communication 806 of FIG. 8).

In certain aspects, the maximum bandwidth is based on a bandwidth associated with the SBFD resources, a bandwidth associated with a bandwidth part (BWP) used for outputting the signaling for transmission, or a component carrier (CC) bandwidth used for outputting the signaling for transmission.

At 908, the UE may optionally obtain an indication of an offset associated the rate-match pattern, wherein the signaling is output for transmission. For example, 908 may be performed by an outputting component 1042. Here, the UE may receive an indication of an RE or RB offset. For example, if the rate-match pattern is comb-2, then the indication of the offset may indicate whether the rate-match pattern begins at a first RE of a slot, or a second RE. In some examples, the indication of the offset may be included in the same messaging used for transmission of the indication of the rate-match pattern (e.g., bandwidth indicated in the third communication 806 of FIG. 8).

In certain aspects, the indication of the offset is obtained via a control message configured to grant the signaling output for transmission.

At 910, the UE may output, via subband full duplex (SBFD) resources, signaling for transmission according to the rate-match pattern. For example, 910 may be performed by an outputting component 1042. Here, the UE may transmit uplink signaling (e.g., PUSCH) with the rate-match pattern applied to the uplink signaling, as shown by the fourth communication 810 of FIG. 8.

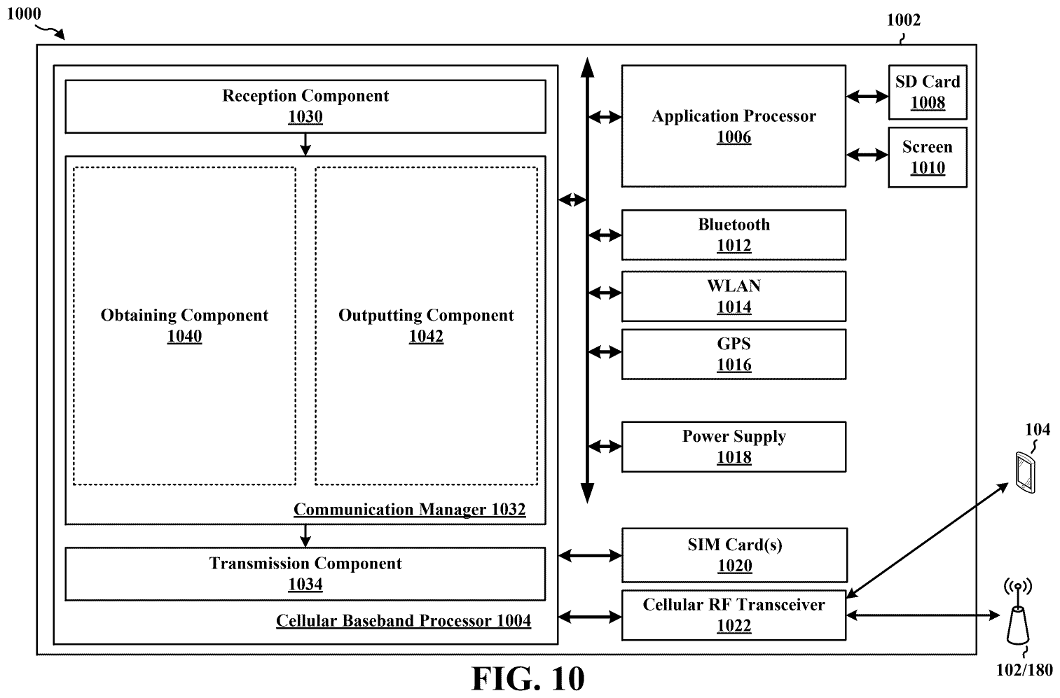

FIG. 10 is a diagram 1000 illustrating an example of a hardware implementation for an apparatus 1002. The apparatus 1002 is a UE and includes a cellular baseband processor 1004 (also referred to as a modem) coupled to one or more cellular RF transceivers 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The cellular baseband processor 1004 communicates through the one or more cellular RF transceivers 1022 with the UE 104 and/or BS 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 104 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire UE (e.g., see UE 104 of FIG. 3) and include the aforediscussed additional modules of the apparatus 1002. In various examples, the apparatus 1002 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes an obtaining component 1040 that is configured to: obtain an indication of a rate-match pattern; obtain an indication of at least one of a periodicity associated with the rate-match pattern or an offset associated with the rate-match pattern, wherein the signaling is output for transmission according to the at least one of the periodicity or the offset; obtain an indication of a maximum bandwidth associated with the rate-match pattern, wherein the signaling is output for transmission according to the maximum bandwidth; and obtain an indication of an offset associated with the rate-match pattern, wherein the signaling is output for transmission according to the offset; e.g., as described in connection with 902, 904, 906, and 908.

The communication manager 1032 further includes an outputting component 1042 configured to output, via subband full duplex (SBFD) resources, signaling for transmission according to the rate-match pattern, e.g., as described in connection with 910.

The apparatus may include additional components that perform each of the blocks of the algorithm in the aforementioned flowchart of FIG. 9. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the cellular baseband processor 1004, includes means for obtaining an indication of a rate-match pattern; means for obtaining an indication of at least one of a periodicity associated with the rate-match pattern or an offset associated with the rate-match pattern, wherein the signaling is output for transmission according to the at least one of the periodicity or the offset; means for obtaining an indication of a maximum bandwidth associated with the rate-match pattern, wherein the signaling is output for transmission according to the maximum bandwidth; means for obtaining an indication of an offset associated with the rate-match pattern, wherein the signaling is output for transmission according to the offset; and means for outputting, via subband full duplex (SBFD) resources, signaling for transmission according to the rate-match pattern.

The aforementioned means may be one or more of the aforementioned components of the apparatus 1002 configured to perform the functions recited by the aforementioned means. As described supra, the apparatus 1002 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Means for receiving or means for obtaining may include a receiver (such as the receive processor 370) and/or an antenna(s) 320 of the network entity 102/180 or the receive processor 356 and/or antenna(s) 352 of the UE 104 illustrated in FIG. 3. Means for transmitting or means for outputting may include a transmitter (such as the transmit processor 316) or an antenna(s) 320 of the network entity 102/180 or the transmit processor 368 or antenna(s) 352 of the UE 104 illustrated in FIG. 3. Means for selecting and means for determining may include a processing system, which may include one or more processors, such as the controller/processor 359, the memory 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

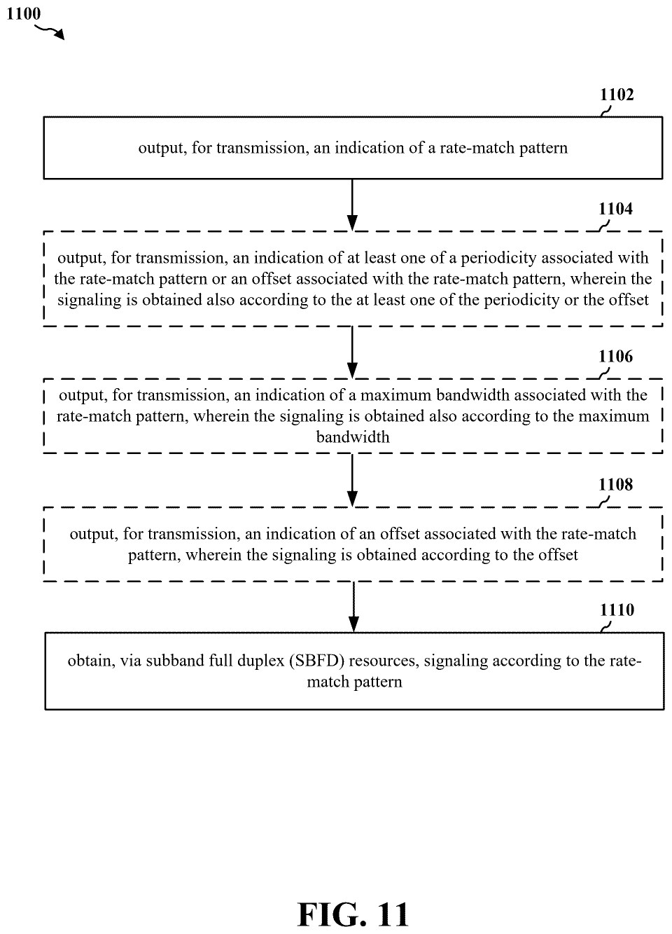

FIG. 11 is a flowchart illustrating a method 1100 of wireless communication. The method may be performed by a network entity or base station (e.g., the base station 102/180; the apparatus 1202. Specifically, the method may be performed by one or more memories, processors, and RF front ends (e.g., the memory 376, controller/processor 375, transmitter 318TX, receiver 318RX, antenna 320, etc. of FIG. 3).

At 1102, the network entity may output, for transmission, an indication of a rate-match pattern. For example, 1102 may be performed by an outputting component 1240. Here, the network entity may transmit information indicating one or rate-matching patterns that the UE may use to mute certain resources of an uplink transmission, as illustrated in the third communication 806 of FIG. 8.

In certain aspects, the indication of the rate-match pattern is output for transmission via a bandwidth part (BWP) configuration information element (IE) of a radio resource control (RRC) configuration message.

In certain aspects, the BWP configuration IE is a component of a physical uplink shared channel (PUSCH) configuration IE of the RRC configuration message.

In certain aspects, the non-legacy IE is a component of a legacy channel state information (CSI) configuration IE of the RRC configuration.

In certain aspects, the signaling is obtained also according to a subcarrier spacing (SCS) associated with the BWP configuration IE.

In certain aspects, the indication of the rate-match pattern is output for transmission via a cell-specific configuration information element (IE) of a radio resource control (RRC) configuration message.

In certain aspects, the cell-specific configuration IE comprises an indication of a subcarrier spacing (SCS), and wherein the signaling is obtained via a bandwidth part (BWP) configured with a same subcarrier spacing (SCS) indicated by the cell-specific configuration IE.

In certain aspects, the signaling is obtained via a bandwidth part (BWP) using a subcarrier spacing (SCS) associated with the BWP.

In certain aspects, the signaling is obtained via a physical uplink shared channel (PUSCH), and wherein the rate-match pattern is configured as a 1-symbol pattern or a 2-symbol pattern per PUSCH transmission.

In certain aspects, the indication of the rate-match pattern further comprises an indication of a fixed offset.

At 1104, the network entity may optionally output, for transmission, an indication of at least one of a periodicity associated with the rate-match pattern or an offset associated with the rate-match pattern, wherein the signaling is obtained also according to the at least one of the periodicity or the offset. For example, 1104 may be performed by the outputting component 1240.

At 1106, the network entity may optionally output, for transmission, an indication of a maximum bandwidth associated with the rate-match pattern, wherein the signaling is obtained also according to the maximum bandwidth. For example, 1106 may be performed by the outputting component 1240.

In certain aspects, the maximum bandwidth is based on: a bandwidth associated with the SBFD resources, a bandwidth associated with a bandwidth part (BWP) used for obtaining the signaling for transmission, or a component carrier (CC) bandwidth used for obtaining the signaling for transmission.

At 1108, the network entity may optionally output, for transmission, an indication of an offset associated with the rate-match pattern, wherein the signaling is obtained according to the offset. For example, 1108 may be performed by the outputting component 1240.

In certain aspects, the indication of the offset is output for transmission via a control message configured to grant the obtained signaling.

At 1110, the network entity may obtain, via subband full duplex (SBFD) resources, signaling according to the rate-match pattern. For example, 1110 may be performed by an obtaining component 1242.

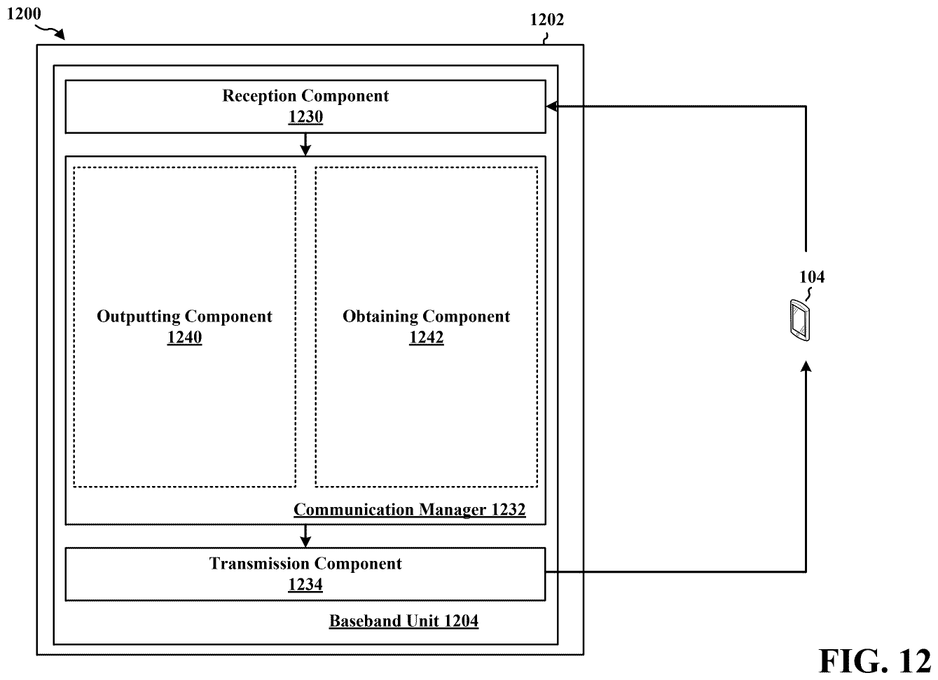

FIG. 12 is a diagram 1200 illustrating an example of a hardware implementation for an apparatus 1202. The apparatus 1202 is a BS and includes a baseband unit 1204. The baseband unit 1204 may communicate through one or more cellular RF transceivers with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the BS 102/180 and may include the memory 376 and/or at least one of the TX processor 316, the RX processor 370, and the controller/processor 375. In various examples, the apparatus 1202 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1232 includes an outputting component 1240 configured to output, for transmission, an indication of a rate-match pattern; output, for transmission, an indication of at least one of a periodicity associated with the rate-match pattern or an offset associated with the rate-match pattern, wherein the signaling is obtained also according to the at least one of the periodicity or the offset; output, for transmission, an indication of a maximum bandwidth associated with the rate-match pattern, wherein the signaling is obtained also according to the maximum bandwidth; and output, for transmission, an indication of an offset associated with the rate-match pattern, wherein the signaling is obtained according to the offset; e.g., as described in connection with 1102, 1104, 1106, and 1108.

The communication manager 1232 further includes an obtaining component 1242 configured to obtain, via subband full duplex (SBFD) resources, signaling according to the rate-match pattern, e.g., as described in connection with 1110.

The apparatus may include additional components that perform each of the blocks of the algorithm in the aforementioned flowchart of FIG. 11. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes means for outputting, for transmission, an indication of a rate-match pattern; means for outputting, for transmission, an indication of at least one of a periodicity associated with the rate-match pattern or an offset associated with the rate-match pattern, wherein the signaling is obtained also according to the at least one of the periodicity or the offset; means for outputting, for transmission, an indication of a maximum bandwidth associated with the rate-match pattern, wherein the signaling is obtained also according to the maximum bandwidth; means for outputting, for transmission, an indication of an offset associated with the rate-match pattern, wherein the signaling is obtained according to the offset; and means for obtaining, via subband full duplex (SBFD) resources, signaling according to the rate-match pattern.

The aforementioned means may be one or more of the aforementioned components of the apparatus 1202 configured to perform the functions recited by the aforementioned means. As described supra, the apparatus 1202 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Means for receiving or means for obtaining may include a receiver, such as the receive processor 370 and/or antenna(s) 320 of the network entity 102/180 illustrated in FIG. 3. Means for transmitting or means for outputting may include a transmitter such as the transmit processor 316 or antenna(s) 320 of the network entity 102/180 illustrated in FIG. 3. Means for selecting and means for determining may include a processing system, which may include one or more processors, such as the controller/processor 375, the memory 376, and/or any other suitable hardware components of the network entity 102/180 illustrated in FIG. 3.

In some cases, rather than actually transmitting a frame, a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### Additional Considerations

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more. ” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration. ” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means. ” As such, no claim element is to be construed as a means plus function unless the element is expressly recited using the phrase “means for.”

### Example Aspects

The following examples are illustrative only and may be combined with aspects of other embodiments or teachings described herein, without limitation.
Example 1 is a method of wireless communication at a wireless node, comprising: obtaining an indication of a rate-match pattern; and outputting, via subband full duplex (SBFD) resources, signaling for transmission according to the rate-match pattern.
Example 2 is the method of Example 1, wherein the indication of the rate-match pattern is obtained via a bandwidth part (BWP) configuration information element (IE) of a radio resource control (RRC) configuration message.
Example 3 is the method of Example 2, wherein the BWP configuration IE is a component of a physical uplink shared channel (PUSCH) configuration IE of the RRC configuration message.
Example 4 is the method of any of Examples 2 and 3, wherein the signaling is output for transmission according to a subcarrier spacing (SCS) associated with the BWP configuration IE.
Example 5 is the method of any of Examples 1-4, wherein the indication of the rate-match pattern is obtained via a cell-specific configuration information element (IE) of a radio resource control (RRC) configuration message.
Example 6 is the method of Example 5, wherein the cell-specific configuration IE comprises an indication of a subcarrier spacing (SCS), and wherein the signaling is output for transmission via a bandwidth part (BWP) configured with a same subcarrier spacing (SCS) indicated by the cell-specific configuration IE.
Example 7 is the method of any of Examples 5 and 6, wherein the signaling is output for transmission via a bandwidth part (BWP) by using a subcarrier spacing (SCS) associated with the BWP.
Example 8 is the method of any of Examples 1-7, further comprising: obtaining an indication of at least one of a periodicity associated with the rate-match pattern or an offset associated with the rate-match pattern, wherein the signaling is output for transmission according to the at least one of the periodicity or the offset.
Example 9 is the method of any of Examples 1-8, wherein at least one of: the signaling is output for transmission via a physical uplink shared channel (PUSCH), or the rate-match pattern is configured as a 1-symbol pattern or a 2-symbol pattern per PUSCH transmission.
Example 10 is the method of any of Examples 1-9, further comprising obtaining an indication of a maximum bandwidth associated with the rate-match pattern, wherein the signaling is output for transmission according to the maximum bandwidth.
Example 11 is the method of Example 10, wherein the maximum bandwidth is based on: a bandwidth associated with the SBFD resources, a bandwidth associated with a bandwidth part (BWP) used for outputting the signaling for transmission, or a component carrier (CC) bandwidth used for outputting the signaling for transmission.
Example 12 is the method of any of Examples 1-11, further comprising: obtaining an indication of an offset associated with the rate-match pattern, wherein the signaling is output for transmission according to the offset.
Example 13 is the method of Example 12, wherein the indication of the offset is obtained via a control message configured to grant the signaling output for transmission.
Example 14 is the method of any of Examples 1-13, wherein the indication of the rate-match pattern further comprises an indication of a fixed offset.
Example 15 is a method for wireless communication at a wireless node, comprising: outputting, for transmission, an indication of a rate-match pattern; and obtaining, via subband full duplex (SBFD) resources, signaling according to the rate-match pattern.
Example 16 is the method of Example 15, wherein the indication of the rate-match pattern is output for transmission via a bandwidth part (BWP) configuration information element (IE) of a radio resource control (RRC) configuration message.
Example 17 is the method of Example 16, wherein the BWP configuration IE is a component of a physical uplink shared channel (PUSCH) configuration IE of the RRC configuration message.
Example 18 is the method of any of Examples 16 and 17, wherein the signaling is obtained also according to a subcarrier spacing (SCS) associated with the BWP configuration IE.
Example 19 is the method of any of Examples 15-18, wherein the indication of the rate-match pattern is output for transmission via a cell-specific configuration information element (IE) of a radio resource control (RRC) configuration message.
Example 20 is the method of Example 19, wherein the cell-specific configuration IE comprises an indication of a subcarrier spacing (SCS), and wherein the signaling is obtained via a bandwidth part (BWP) configured with a same subcarrier spacing (SCS) indicated by the cell-specific configuration IE.
Example 21 is the method of any of Examples 19 and 20, wherein the signaling is obtained via a bandwidth part (BWP) using a subcarrier spacing (SCS) associated with the BWP.
Example 22 is the method of any of Examples 15-21, further comprising: outputting, for transmission, an indication of at least one of a periodicity associated with the rate-match pattern or an offset associated with the rate-match pattern, wherein the signaling is obtained also according to the at least one of the periodicity or the offset.
Example 23 is the method of any of Examples 15-22, wherein the signaling is obtained via a physical uplink shared channel (PUSCH), and wherein the rate-match pattern is configured as a 1-symbol pattern or a 2-symbol pattern per PUSCH transmission.
Example 24 is the method of any of Examples 15-23, further comprising: outputting, for transmission, an indication of a maximum bandwidth associated with the rate-match pattern, wherein the signaling is obtained also according to the maximum bandwidth.
Example 25 is the method of Example 24, wherein the maximum bandwidth is based on: a bandwidth associated with the SBFD resources, a bandwidth associated with a bandwidth part (BWP) used for obtaining the signaling for transmission, or a component carrier (CC) bandwidth used for obtaining the signaling for transmission.
Example 26 is the method of any of Examples 15-25, further comprising: outputting, for transmission, an indication of an offset associated with the rate-match pattern, wherein the signaling is obtained according to the offset.
Example 27 is the method of Example 26, wherein the indication of the offset is output for transmission via a control message configured to grant the obtained signaling.
Example 28 is the method of any of Examples 15-27, wherein the indication of the rate-match pattern further comprises an indication of a fixed offset.
Example 29 is an apparatus for wireless communications, comprising means for performing a method in accordance with any one of examples 1-14.
Example 30 is an apparatus for wireless communications, comprising means for performing a method in accordance with any one of examples 15-28.
Example 31 is a non-transitory computer-readable medium comprising instructions that, when executed by a wireless node, cause the wireless node to perform a method in accordance with any one of examples 1-14.
Example 32 is a non-transitory computer-readable medium comprising instructions that, when executed by a wireless node, cause the wireless node to perform a method in accordance with any one of examples 15-28.
Example 33 is an apparatus for wireless communications, comprising: one or more memories, individually or in combination, having instructions; and one or more processors, individually or in combination, configured to execute the instructions and cause the apparatus to perform a method in accordance with any one of examples 1-14.
Example 34 is an apparatus for wireless communications, comprising: one or more memories, individually or in combination, having instructions; and one or more processors, individually or in combination, configured to execute the instructions and cause the apparatus to perform a method in accordance with any one of examples 15-28.
Example 35 is a wireless node, comprising: one or more transceivers; one or more memories, individually or in combination, having instructions; and one or more processors, individually or in combination, configured to execute the instructions and cause the wireless node to perform a method in accordance with any one of examples 1-14, wherein the one or more transceivers are configured to: receive the indication of the rate-match pattern; and transmit the signaling according to the rate-match pattern.
Example 36 is a wireless node, comprising: one or more transceivers; one or more memories, individually or in combination, having instructions; and one or more processors, individually or in combination, configured to execute the instructions and cause the wireless node to perform a method in accordance with any one of examples 15-28, wherein the one or more transceivers are configured to: transmit the indication of the rate-match pattern; and receive the signaling according to the rate-match pattern.

What is claimed is:

1. An apparatus for wireless communication, comprising:
one or more memories, individually or in combination, having instructions; and
one or more processors, individually or in combination, configured to execute the instructions and cause the apparatus to:
obtain an indication of a rate-match pattern; and
output, via subband full duplex (SBFD) resources, signaling for transmission according to the rate-match pattern.

2. The apparatus of claim 1, wherein the indication of the rate-match pattern is obtained via a bandwidth part (BWP) configuration information element (IE) of a radio resource control (RRC) configuration message.

3. The apparatus of claim 2, wherein the BWP configuration IE is a component of a physical uplink shared channel (PUSCH) configuration IE of the RRC configuration message.

4. The apparatus of claim 2, wherein the signaling is output for transmission according to a subcarrier spacing (SCS) associated with the BWP configuration IE.

5. The apparatus of claim 1, wherein the indication of the rate-match pattern is obtained via a cell-specific configuration information element (IE) of a radio resource control (RRC) configuration message.

6. The apparatus of claim 5, wherein the cell-specific configuration IE comprises an indication of a subcarrier spacing (SCS), and wherein the signaling is output for transmission via a bandwidth part (BWP) configured with a same subcarrier spacing (SCS) indicated by the cell-specific configuration IE.

7. The apparatus of claim 5, wherein the signaling is output for transmission via a bandwidth part (BWP) by using a subcarrier spacing (SCS) associated with the BWP.

8. The apparatus of claim 1, wherein the one or more processors, individually or in combination, are further configured to cause the apparatus to:
obtain an indication of at least one of a periodicity associated with the rate-match pattern or an offset associated with the rate-match pattern, wherein the signaling is output for transmission according to the at least one of the periodicity or the offset.

9. The apparatus of claim 1, wherein at least one of:
the signaling is output for transmission via a physical uplink shared channel (PUSCH), or
the rate-match pattern is configured as a 1-symbol pattern or a 2-symbol pattern per PUSCH transmission.

10. The apparatus of claim 1, wherein the one or more processors, individually or in combination, are further configured to cause the apparatus to:
obtain an indication of a maximum bandwidth associated with the rate-match pattern, wherein the signaling is output for transmission according to the maximum bandwidth.

11. The apparatus of claim 10, wherein the maximum bandwidth is based on: a bandwidth associated with the SBFD resources, a bandwidth associated with a bandwidth part (BWP) used for outputting the signaling for transmission, or a component carrier (CC) bandwidth used for outputting the signaling for transmission.

12. The apparatus of claim 1, wherein the one or more processors, individually or in combination, are further configured to cause the apparatus to:
obtain an indication of an offset associated with the rate-match pattern, wherein the signaling is output for transmission according to the offset.

13. The apparatus of claim 12, wherein the indication of the offset is obtained via a control message configured to grant the signaling output for transmission.

14. The apparatus of claim 1, wherein the indication of the rate-match pattern further comprises an indication of a fixed offset.

15. The apparatus of claim 1, further comprising one or more transceivers configured to:
receive the indication of the rate-match pattern; and
transmit the signaling according to the rate-match pattern, wherein the apparatus comprises a user equipment (UE).

16. An apparatus for wireless communication, comprising:
one or more memories, individually or in combination, having instructions; and
one or more processors, individually or in combination, configured to execute the instructions and cause the apparatus to:
output, for transmission, an indication of a rate-match pattern; and
obtain, via subband full duplex (SBFD) resources, signaling according to the rate-match pattern.

17. The apparatus of claim 16, wherein the indication of the rate-match pattern is output for transmission via a bandwidth part (BWP) configuration information element (IE) of a radio resource control (RRC) configuration message.

18. The apparatus of claim 17, wherein the BWP configuration IE is a component of a physical uplink shared channel (PUSCH) configuration IE of the RRC configuration message.

19. The apparatus of claim 17, wherein the signaling is obtained also according to a subcarrier spacing (SCS) associated with the BWP configuration IE.

20. The apparatus of claim 16, wherein the indication of the rate-match pattern is output for transmission via a cell-specific configuration information element (IE) of a radio resource control (RRC) configuration message.

21. The apparatus of claim 20, wherein the cell-specific configuration IE comprises an indication of a subcarrier spacing (SCS), and wherein the signaling is obtained via a bandwidth part (BWP) configured with a same subcarrier spacing (SCS) indicated by the cell-specific configuration IE.

22. The apparatus of claim 20, wherein the signaling is obtained via a bandwidth part (BWP) using a subcarrier spacing (SCS) associated with the BWP.

23. The apparatus of claim 16, wherein the one or more processors, individually or in combination, are further configured to cause the apparatus to:
output, for transmission, an indication of at least one of a periodicity associated with the rate-match pattern or an offset associated with the rate-match pattern, wherein the signaling is obtained also according to the at least one of the periodicity or the offset.

24. The apparatus of claim 16, wherein the signaling is obtained via a physical uplink shared channel (PUSCH), and wherein the rate-match pattern is configured as a 1-symbol pattern or a 2-symbol pattern per PUSCH transmission.

25. The apparatus of claim 16, wherein the one or more processors, individually or in combination, are further configured to cause the apparatus to:
output, for transmission, an indication of a maximum bandwidth associated with the rate-match pattern, wherein the signaling is obtained also according to the maximum bandwidth.

26. The apparatus of claim 25, wherein the maximum bandwidth is based on: a bandwidth associated with the SBFD resources, a bandwidth associated with a bandwidth part (BWP) used for obtaining the signaling for transmission, or a component carrier (CC) bandwidth used for obtaining the signaling for transmission.

27. The apparatus of claim 16, wherein the one or more processors, individually or in combination, are further configured to cause the apparatus to:
output, for transmission, an indication of an offset associated with the rate-match pattern, wherein the signaling is obtained according to the offset.

28. The apparatus of claim 27, wherein at least one of:
the indication of the offset is output for transmission via a control message configured to grant the obtained signaling; or
the indication of the rate-match pattern further comprises an indication of a fixed offset.

29. The apparatus of claim 16, further comprising one or more transceivers configured to:
transmit the indication of the rate-match pattern; and
receive the signaling according to the rate-match pattern, wherein the apparatus comprises a network entity.

30. A method for wireless communications at a wireless node, comprising:
obtaining an indication of a rate-match pattern; and
outputting, via subband full duplex (SBFD) resources, signaling for transmission according to the rate-match pattern.
